(19) United States
(12) Patent Application Publication
(10) Pub. No.: US 2005/0233084 A1
(43) Pub. Date: Oct. 20, 2005

(54) Method for treating a contact surface for a mullite-based refractory recipient, and a coating made with this method

(75) Inventors: Christian Marty, Boulogne (FR); Umberto Aprile, Rueil-Malmaison (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, Paris (FR)

(21) Appl. No.: 10/825,321

(22) Filed: Apr. 16, 2004

(51) Int. Cl. B05D 3/02; C04B 35/185

(52) U.S. Cl. 427/372.2; 501/128

(57) ABSTRACT

The invention proposes a method for passivating the contact surface of a refractory container made of mullite. Such a method is remarkable in that it comprises the following operations:
a. application to the contact surface of a coating comprising 50% to 70% by weight of alumina flour (Al₂O₃) filler and 30% to 50% of binder, this binder itself comprising 50% to 60% of aluminum chloride AlCl₃ dissolved in 40% to 50% of water; b. drying; c. firing of the container in an oxidizing atmosphere between 1450° C. and 1550° C. for at least 20 min. Application to the casting of titanium alloys.

### TECHNICAL FIELD OF THE INVENTION

The invention relates to foundry practice for metallic alloys and more particularly to a method and to products for passivating the contact surface of mullite based ceramic containers such as crucibles and molds.

The terms “mullite based” or “more mostly of mullite” mean containers of pure mullite or containers in which the most important component by weight is mullite.

### PRIOR ART AND PROBLEM POSED

Mullite, or aluminum silicate with the chemical formula 2SiO₂.3Al₂O₃, is a cheap material used to fabricate refractory containers exhibiting excellent resistance to the thermal shocks caused by the casting of metals and alloys in foundries. Cheap crucibles of pure mullite or of a material comprising mostly mullite are in particular available on the market. Mullite is also used to fabricate foundry molds, for example ingot molds.

Titanium alloys are widely used in aeronautics, but they present the drawback of reacting chemically at elevated temperature with most materials used to make the crucibles and the molds containing them, and in particular with silica SiO₂, whether pure or a component of mullite. In the castings, these reactions cause inclusions of undesirable components that are liable to weaken the castings. To remedy this situation, it is known to coat the contact surface of the container with a layer of an inert material such as alumina. To do this:
an aqueous suspension called “slurry” is prepared, consisting of a filler of alumina (Al₂O₃) flour, with a product called “binder”, this binder itself being a mixture of water and colloidal silica SiO₂;
this compound is applied to the contact surface;
the container is dried;
the container is fired at high temperature, typically 1200° C., for one hour, this firing causing the crystallization of the components and the constitution of a hard and resistant contact layer.

It is known that the silica in the binder reacts chemically with the titanium. It should also be observed that a container made exclusively of alumina would be perfectly chemically inert to titanium, but it would be too brittle to withstand the thermal shocks during casting of the molten metal.

A first problem is to provide, on the contact surface of ceramic containers made of material mainly composed of mullite, or even of pure mullite, a coating that is perfectly inert to molten titanium alloys.

A second problem is to apply such coatings at low cost.

### SUMMARY OF THE INVENTION

To solve this problem, the invention proposes a method for passivating the contact surface of a refractory container made of mullite. Such a method is noteworthy in that it comprises the following operations:
a. application to the contact surface of a coating comprising 50% to 70% by weight of alumina flour (Al₂O₃) filler and 30% to 50% of binder, this binder itself comprising 50% to 60% of aluminum chloride AlCl₃ dissolved in 40% to 50% of water;
b. drying;
c. firing of the container in an oxidizing atmosphere between 1450° C. and 1550° C. for at least 20 min.

The inventors have found that an aluminum chloride solution exhibits a binding power comparable to the conventional suspension of colloidal silica. During the oxidizing firing, the aluminum in the binder is converted to alumina, crystallizing with the alumina of the filler, while the chlorine thus liberated escapes in gaseous form. This produces an alumina contact layer that is perfectly pure and able to enter into contact with molten titanium without chemically reacting with it, thereby solving the first problem.

The method is economical because:
the ingredients used are cheap;
the firing, although occurring at high temperatures, remains short;
the coating can be applied simply by air brush or by brush, depending on the proportions of filler and binder selected,
   thereby solving the second problem.

The invention also proposes a coating specially designed to put this method into practice.

### DETAILED DESCRIPTION

The invention will be better understood and the advantages it procures will appear more clearly in light of a detailed and commented-upon example of how to put it into practice.

The method of the present invention comprises the following operations:
1) Preparation of a slurry consisting of a filler of alumina flour Al₂O₃, binder and an infinitesimal quantity of methylene blue.

The alumina is called flour because it is a very fine powder with a particle size of about 40 μm. The alumina flour Al₂O₃ constitutes the filler of the slurry and constitutes 50% to 70% of the total weight of the slurry.

The binder consequently constitutes 30% to 50% of the total weight of the slurry. This binder is a solution of aluminum chloride AlCl₃ dissolved in water, the aluminum chloride AlCl₃ constituting 50% to 60% of the total weight of the binder and the water consequently constituting 40% to 50% of the total weight of the binder.
2) Application of the slurry to the contact surface of the container, this application being feasible by known means.

With 50% to 55% of alumina flour (Al₂O₃) filler and 45% to 50% of binder, the slurry obtained is relatively fluid and can be applied by air brush.

With 55% to 70% of alumina flour (Al₂O₃) filler and 30% to 45% of binder, the slurry obtained is thicker and will preferably be applied by brush.

With more than 70% of alumina flour (Al₂O₃) filler and less than 30% of binder, the slurry becomes very thick and can be applied in thin layers only with difficulty.

On the contrary, with less than 50% of alumina flour (Al₂O₃) filler and more than 50% of binder, the slurry becomes too liquid and has the drawback of shrinking and cracking during drying.

The coating also comprises a water-soluble organic dye.

Since the mullite, alumina and aluminum chloride are white in color, the coloration of the slurry with methylene blue serves to visually monitor the thickness and uniformity of the coating. In practice, methylene blue will account for 0.1% to 0.5% of the total weight of the slurry. Methylene blue can obviously be replaced by any pyrolyzable organic dye, that is one destructible with heat, but having a high dyeing power, in order to make it suitable for use in a very small quantity in order not to impair the coating.
3) Drying of the coating by known means, for example by placing the container in an oven for one hour at 120° C.
4) Firing of the coating in a kiln in oxidizing atmosphere at a temperature between 1450° C. and 1550° C. for 20 minutes to one hour, typically at 1500° C. for 30 minutes, the rate of temperature rise and of temperature fall nonetheless having to remain less than 300° C. per hour in order to limit the thermal expansion stresses.

The oxidizing atmosphere can simply be ambient air. During the oxidizing firing step, the aluminum of the aluminum chloride is converted to alumina and fills the volume initially occupied by the binder, while the chlorine is liberated and escapes in gaseous form.

1. A method for passivating the contact surface of a refractory container made mainly of mullite, which comprises the following operations:
a. application to the contact surface of a coating comprising 50% to 70% by weight of alumina flour (Al₂O₃) filler and 30% to 50% of binder, this binder itself comprising 50% to 60% of aluminum chloride AlCl₃ dissolved in 40% to 50% of water;
b. drying;
c. firing of the container in an oxidizing atmosphere between 1450° C. and 1550° C. for at least 20 minutes.

2. The method as claimed in claim 1, wherein the coating also comprises a water-soluble organic dye.

3. The method as claimed in claim 2, wherein the dye is methylene blue in a total proportion of 0.1% to 0.5% by weight.

4. The method as claimed in one of claims 1 to 3, wherein the coating comprises 50% to 55% by weight of alumina flour (Al₂O₃) filler and 45% to 50% of binder, and wherein it is applied by air brush.

5. The method as claimed in one of claims 1 to 3, wherein the coating comprises 55% to 70% by weight of alumina flour (Al₂O₃) filler and 30% to 45% of binder, and wherein it is applied by brush.

6. A coating used in the method claimed, which comprises 50% to 70% by weight of alumina flour (Al₂O₃) filler and 30% to 50% of binder, this binder itself comprising 50% to 60% of aluminum chloride AlCl₃ dissolved in 40% to 50% of water.

7. The coating as claimed in claim 6, which comprises 50% to 55% by weight of alumina flour (Al₂O₃) filler and 45% to 50% of binder.

8. The coating as clainmed in claim 6, which comprises 55% to 70% by weight of alumina flour (Al₂O₃) filler and 30% to 45% of binder.
